(19) United States
(12) Patent Application Publication
(10) Pub. No.: US 2008/0197829 A1
(43) Pub. Date: Aug. 21, 2008

(54) Semiconductor Device and Voltage Regulator Using the Semiconductor Device

(76) Inventors: Toshihisa Nagata, Hyogo (JP); kohji Yoshii, Hyogo (JP)

Correspondence Address: DICKSTEIN SHAPIRO LLP, 1825 EYE STREET NW, Washington, DC, 20006-5403, US

(21) Appl. No.: 10/577,666

(22) PCT Filed: Sep. 21, 2005
(86) PCT No.: PCT/JP2005/017919

§ 371 Date: May 1, 2006

(30) Foreign Application Priority Data
Sep. 22, 2004 (JP) 2004-275293

(51) Int. Cl. G05F 3/16

(52) U.S. Cl. 323/316

(57) ABSTRACT

A semiconductor device provided with a monitor transistor for detecting electric current flowing in a driver transistor mounted on a semiconductor chip is disclosed. The semiconductor device includes plural transistors provided in the monitor transistor and connected in parallel. The plural transistors are disposed at a periphery of an area of the semiconductor chip on which the driver transistor is mounted.

### TECHNICAL FIELD

The present invention relates to a semiconductor device including a monitor transistor having electric current flowing therethrough in proportion to electric current flowing in a driver transistor for monitoring the flow of the electric current of the driver transistor, and a voltage regulator using the semiconductor device.

### BACKGROUND ART

In a conventional voltage regulator shown in FIG. 5, the voltage regulator includes a circuit having a voltage control driver transistor Ma that controls the electric current applied to a load and enables constant voltage to be applied to the load. The voltage regulator also includes a monitor transistor Mb which outputs an electric current proportional to the electric current output from the voltage control driver transistor Ma for detecting and feeding back the electric current flowing in the voltage control driver transistor Ma. In a case where the circuit of FIG. 5 is operating, the voltage control driver transistor Ma is heated by the electric current flowing therethrough.

However, since the voltage control driver transistor Ma usually occupies a large area on a semiconductor chip, the area is not evenly heated to a uniform temperature. Instead, a center part of the area has a temperature which is higher than that of a peripheral part of the area. Furthermore, in some cases, the temperature exhibits a distribution inclining from one area to another area when multiple driver transistors are disposed in an aligned manner. Therefore, when the driver transistor Ma is operating, the temperature of the driver transistor Ma is the average temperature obtained from the temperature distribution of the area occupied by the driver transistor Ma.

Therefore, as shown in FIG. 6, the temperature of the monitor transistor Mb does not necessarily match the average temperature of the driver transistor Ma even when the monitor transistor Mb is disposed in the vicinity of the driver transistor Ma. As a result, the difference between the temperature of the driver transistor Ma and the temperature of the monitor transistor Mb becomes greater as the temperature of the driver transistor Ma rises as the circuit continues to operate. This prevents the electric current flowing in the driver transistor Ma from being detected accurately.

Furthermore, since the driver transistor Ma is formed in a manner covering a large area on the semiconductor chip, even a slight amount of stress created when mounting the semiconductor chip on a package causes a change in the property of the driver transistor Ma and in the property relationship between the driver transistor Ma and the monitor transistor Mb. This causes undesired fluctuation in the proportion between the electric current flowing in the driver transistor Ma and the electric current flowing in the monitor transistor Mb.

### DISCLOSURE OF INVENTION

It is a general object of the present invention to provide a semiconductor device and a voltage regulator that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention can be realized and attained by a semiconductor device and a voltage regulator particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a semiconductor device provided with a monitor transistor for detecting electric current flowing in a driver transistor mounted on a semiconductor chip, the semiconductor device including: a plurality of transistors provided in the monitor transistor and connected in parallel; wherein the plural transistors are disposed at a periphery of an area of the semiconductor chip on which the driver transistor is mounted.

Furthermore, the present invention provides a semiconductor device provided with a monitor transistor for detecting electric current flowing in a driver transistor mounted on a semiconductor chip, the semiconductor device including: a plurality of transistors provided in the monitor transistor and connected in parallel; wherein the plural transistors are disposed within an area of the semiconductor chip on which the driver transistor is mounted.

In the semiconductor device according to an embodiment of the present invention, the plural transistors may be disposed on the semiconductor chip at equal intervals.

In the semiconductor device according to an embodiment of the present invention, the driver transistor and the monitor transistor may be MOS transistors.

Furthermore, the present invention provides a voltage regulator provided with a constant voltage circuit part including a driver transistor mounted on a semiconductor chip and an output current detection circuit part including a monitor transistor for detecting electric current flowing in the driver transistor, the voltage regulator including: a plurality of transistors provided in the monitor transistor and connected in parallel; wherein the plural transistors are disposed at a periphery of an area of the semiconductor chip on which the driver transistor is mounted.

Furthermore, the present invention provides a voltage regulator provided with a constant voltage circuit part including a driver transistor mounted on a semiconductor chip and an output current detection circuit part including a monitor transistor for detecting electric current flowing in the driver transistor, the voltage regulator including a plurality of transistors provided in the monitor transistor and connected in parallel; wherein the plural transistors are disposed within an area of the semiconductor chip on which the driver transistor is mounted.

In the voltage regulator according to an embodiment of the present invention, the plural transistors may be disposed on the semiconductor chip at equal intervals.

In the voltage regulator according to an embodiment of the present invention, the output current detection circuit part may be configured to change the electric current flowing in the monitor transistor into electric voltage and output the electric voltage.

In the voltage regulator according to an embodiment of the present invention, the constant voltage circuit part may further include a reference voltage generation circuit for generating and outputting a reference voltage and an operational amplifier circuit including a differential pair for controlling the operation of the driver transistor, wherein the output current detection circuit part may be configured to supply an electric current to the differential pair of the operational amplifier circuit, wherein the electric current supplied to the differential pair may be proportional to the electric current flowing in the monitor transistor.

In the voltage regulator according to an embodiment of the present invention, the driver transistor and the monitor transistor may be MOS transistors.

In the voltage regulator according to an embodiment of the present invention, the constant voltage circuit part and the output current detection circuit part may be integrated on a single integrated circuit.

### BRIEF DESCRIPTION OF DRAWINGS

FIG. 1 is a circuit diagram showing an exemplary configuration of a voltage regulator using a semiconductor device according to the first embodiment of the present invention;

FIG. 2 is a circuit diagram showing another exemplary configuration of a voltage regulator using a semiconductor device according to the first embodiment of the present invention;

FIG. 3 is a schematic diagram showing an example of a semiconductor device according to the first embodiment of the present invention;

FIG. 4 is a schematic diagram showing another example of a semiconductor device according to the first embodiment of the present invention;

FIG. 5 is a circuit diagram showing an exemplary configuration of a voltage regulator using a semiconductor device according to the related art; and

FIG. 6 is a schematic diagram showing a semiconductor device according to the related art.

### BEST MODE FOR CARRYING OUT THE INVENTION

The present invention is described in detail based on the embodiments illustrated in the drawings.

### First Embodiment

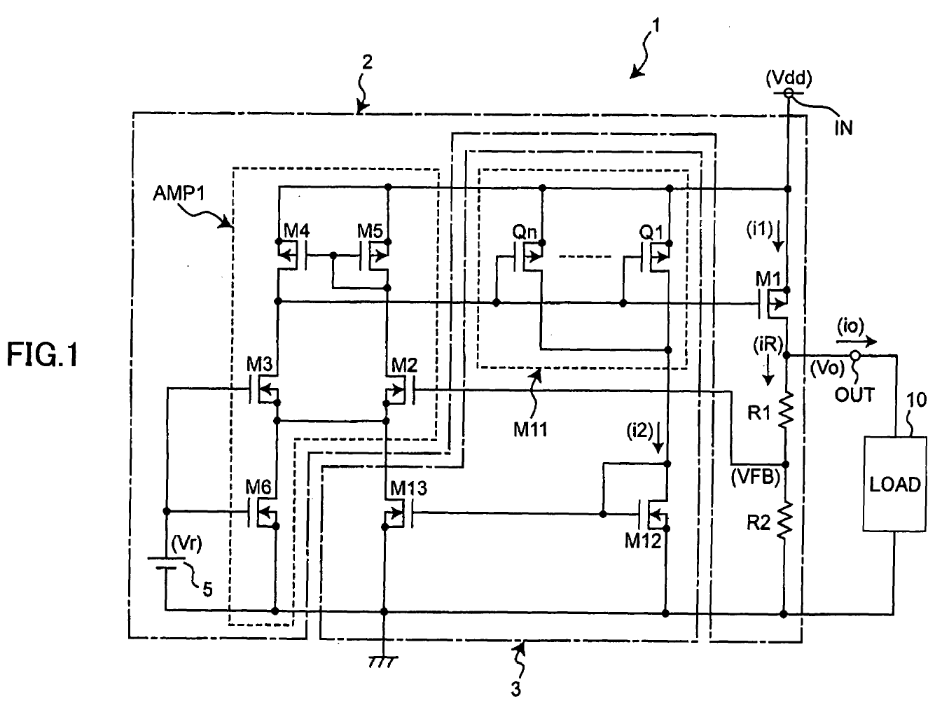

FIG. 1 is a circuit diagram showing an exemplary configuration of a voltage regulator 1 using a semiconductor device according to the first embodiment of the present invention.

In FIG. 1, the voltage regulator 1 includes a constant voltage circuit part 2 and an output current detection circuit part 3. The constant voltage circuit part 2 converts a source voltage Vdd input from an input terminal IN to a predetermined constant voltage and outputs a current io from an output terminal OUT to a load 10. The output current detection circuit part 3 detects the current io output from the output terminal OUT and outputs a current in correspondence with the detected current io. It is to be noted that the constant voltage circuit part 2 and the output current detection circuit part 3 may be integrated on a single IC (integrated circuit), for example.

The constant voltage circuit part 2 includes, for example, a driver transistor M1, resistors R1 and R2, a reference voltage generation circuit 5, and an operational amplifier AMP1. The driver transistor M1, which is a PMOS transistor, serves to control the voltage of the output terminal OUT so that the voltage becomes a predetermined constant voltage by applying a gate voltage corresponding to the current output from the output terminal OUT. The resistors R1 and R2 serve to divide the output voltage Vo and generate a divided voltage VFB (flat-band voltage). The reference voltage generation circuit 5 serves to generate and output a predetermined reference voltage Vr. The operational amplifier circuit AMP1 serves to control the operation of the driver transistor M1 so that the divided voltage VFB may become a voltage equal to the reference voltage Vr. It is to be noted that the resistors R1 and R2 form an output voltage detection circuit.

The driver transistor M1 and the resistors R1, R2 are connected in series between a source voltage Vdd and ground voltage. The junction part between the driver transistor M1 and the resistor R1 is connected to the output terminal OUT. The resistors R1 and R2 divide the output voltage Vo and generate a divided voltage VFB. The divided voltage VFB is input to a non-inverting input terminal of the operational amplifier circuit AMP1. The reference voltage Vr is input to the inverting input terminal of the operational amplifier circuit AMP1. The output terminal of the operational amplifier circuit AMP1 is connected to a gate of the driver transistor M1. It is to be noted that the resistors R1 and R2 included in the constant voltage circuit part 2 have large resistance value. The current iR flowing in the resistors R1 and R2 is so small compared to the current i1 flowing in the driver transistor M1 that it can be ignored. Therefore, the current io output from the output terminal OUT has a value which is substantially equal to that of the current i1.

The operational amplifier circuit AMP1 includes NMOS transistors M2, M3 serving as a differential pair, PMOS transistors M4, M5 (which form a current mirror circuit serving as a load of the differential pair), and an NMOS transistor M6 serving as a current source of the differential pair. Each source for the PMOS transistor M4 and PMOS transistor M5 is connected to the source voltage Vdd. The gate for the PMOS transistor M4 and the gate for the PMOS transistor M5 are connected, and the junction part of the gates is connected to the drain of the PMOS transistor M5. The drain of the NMOS transistor M3 is connected to the drain of the PMOS transistor M4. The junction part of the drains serves as the output terminal of the operational amplifier circuit AMP1 and is connected to the gate of the driver transistor M1. The divided voltage VFB is input to the gate of the NMOS transistors M2. The reference voltage Vr is input to the gate of the NMOS transistor M3. The source of the NMOS transistor M2 and the source of the NMOS transistor M3 are connected. The NMOS transistor M6 is connected between the junction part of the sources and ground voltage. The reference voltage Vr is input to the gate of the NMOS transistor M6. Thus, the NMOS transistor M6 serves as a constant current source.

Next, the output current detection circuit part 3 includes a monitor transistor M11, an NMOS transistor M12, and an NMOS transistor M13. The monitor transistor M11, which is a PMOS transistor, is input with a gate voltage that is equal to that of the driver transistor M1. Furthermore, an electric current equal to the drain current i2 of the monitor transistor M11 flows in the NMOS transistor M12. The NMOS transistor M13 serves as a current mirror circuit with respect to the NMOS transistor M12. Furthermore, the monitor transistor M11 includes multiple PMOS transistors Q1-Qn (n being an integer greater than 1, n>1) that are connected in parallel. The gates of each of the PMOS transistors Q1-Qn are connected and the junction parts thereof serve as the gate of the monitor transistor M11. The sources of each of the PMOS transistors Q1-Qn are connected, and the junction parts thereof serve as the source of the monitor transistor M11. The drains of each of the PMOS transistors Q1-Qn are connected, and the junction parts thereof serve as the drain of the monitor transistor M11.

The monitor transistor M11 and the NMOS transistor M12 are connected in series between the source voltage Vdd and ground voltage. The gate of the monitor transistor M11 is connected to the gate of the driver transistor M1. The gates of each of the NMOS transistors M12 and M13 are connected, and the junction part thereof is connected to the drain of the NMOS transistor M12. The NMOS transistor M13 is connected in parallel with the NMOS transistor M6.

Accordingly, when the current i1 flowing in the driver transistor M1 increases, the current flowing in the monitor transistor M11 for monitoring the current i1 as well as the current supplied from the NMOS transistor M13 increase. Therefore, the current supplied from the NMOS transistors M2 and M3 (serving as a differential pair) increases and the response speed of the operational amplifier circuit AMP1 with respect to changes of the divided voltage VFB increases. On the other hand, when the current i1 flowing in the driver transistor M1 decreases, the current flowing in the monitor transistor M11 for monitoring the current i1 as well as the current supplied from the NMOS transistor M13 decrease. Therefore, when the current supplied from the NMOS transistors M2 and M3 (serving as a differential pair) decreases and the response speed of the operational amplifier circuit AMP1 with respect to changes of the divided voltage VFB decreases, the amount of power consumption is reduced.

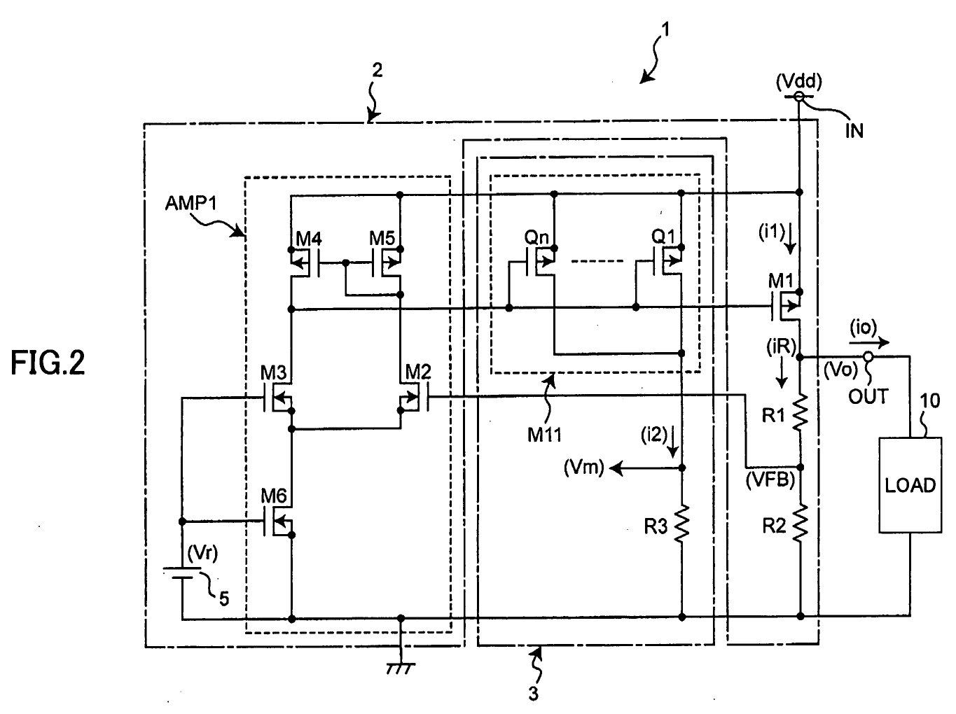

Although the output current detection circuit part 3 described with FIG. 1 outputs an electric current that is proportional to the current i1 flowing in the driver transistor M1, the current proportional to the current i1 may alternatively be converted into electric voltage with a resistor R3 and output as electric voltage (see FIG. 2). The electric voltage may be used for, for example, a circuit for preventing overcurrent of the driver transistor M1 or a circuit for controlling the current of the driver transistor M1.

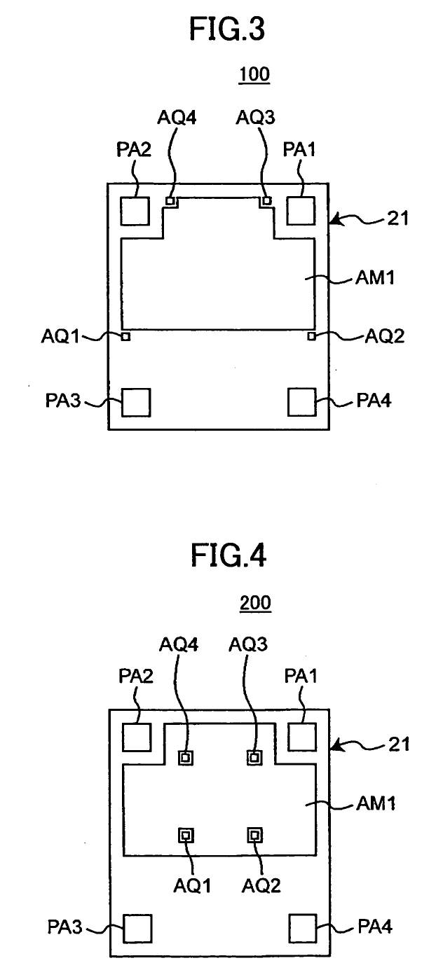

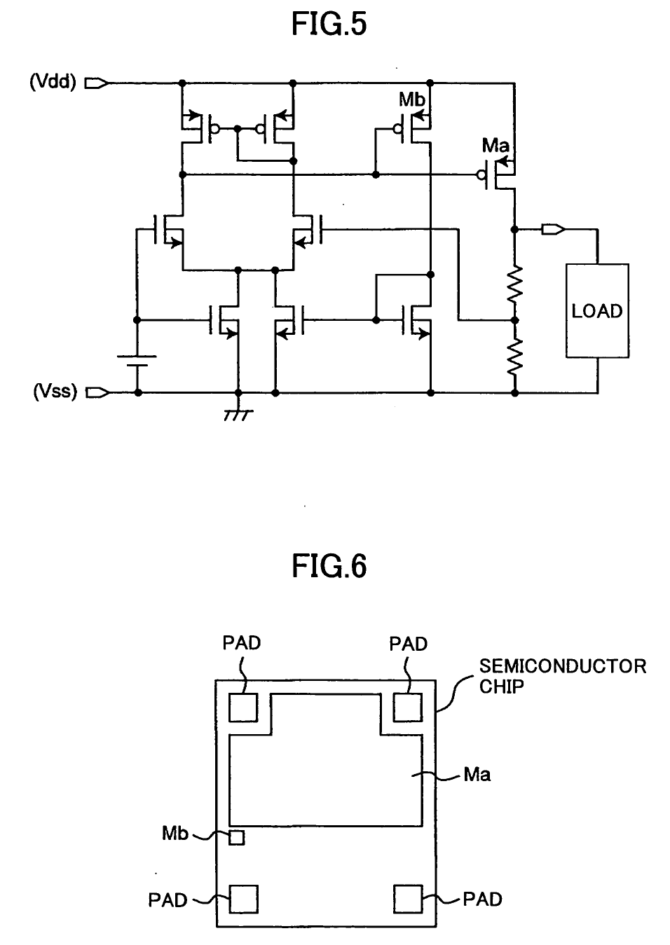

FIG. 3 is a schematic diagram for showing an example of a semiconductor device 100 according to the first embodiment of the present invention. FIG. 3 shows an exemplary arrangement of the area of each transistor Q1-Qn in a case where the driver transistor M1 and the monitor transistor M11 shown in FIG. 1 are formed on a semiconductor chip 21. It is to be noted that, in this example, n of transistor Qn is 4 (n=4).

In FIG. 3, reference numeral 21 indicates the semiconductor chip, reference numerals PA1 through PA4 indicate pads used for connecting the semiconductor chip 21 and an outside circuit, reference numeral AM1 indicates an area at which the driver transistor M1 is formed (mounted), and reference numerals AQ1 through AQ4 indicate the areas at which the PMOS transistors Q1 to Q4 of the monitor transistor M11 are formed (mounted).

The driver transistor M1 mounted on the area AM1 may be formed as a single transistor having a size that is equal to the area AM1 or may alternatively be formed as a single unit including multiple transistors (cell units). Likewise, each of the PMOS transistors Q1-Q4 mounted on corresponding areas AQ1-AQ4 may be formed as a single transistor or may alternatively be formed as a single unit including multiple transistors (cell units). For the sake of convenience, the single unit including multiple transistors is also referred to as “transistor”.

As exemplarily illustrated in FIG. 3, the PMOS transistors Q1-Q4 of the monitor transistor M11 are disposed at the periphery of the area AM1 of the driver transistor M1. The areas AQ1-AQ4 of the PMOS transistors Q1-Q4 may be evenly spaced, that is, disposed at equal intervals. The PMOS transistors Q1-Q4 are connected in parallel and operate as a single unit including multiple PMOS transistors (combined PMOS transistor). Accordingly, since the temperature of the monitor transistor M11 (combined PMOS transistor) becomes the average temperature obtained from the temperatures of the MOS transistors of the PMOS transistors Q1-Q4, the temperature of the monitor transistor M11 can be a temperature that is close to the average temperature of the driver transistor M1.

Accordingly, in terms of the temperature distribution of the area AM1 (at which the driver transistor M1 is formed) according to an embodiment of the present invention, temperature typically becomes higher to the center portion of the area AM1 and becomes lower further from the center portion of the area AM1 (closer to the periphery of the area AM1). Therefore, the average temperature of the driver transistor M1 is substantially equal to the temperature at a substantially middle area between the center portion of the area AM1 and the periphery of the area AM1. Accordingly, by disposing the PMOS transistors Q1-Q4 in the middle area between the center portion of the area AM1 and the periphery of the area AM1, the average temperature of the driver transistor M1 can be closer to the average temperature of the PMOS transistor Q1-Q4. This exemplary arrangement of the area of each PMOS transistor Q1-Q4 is illustrated in FIG. 4, in which another example of a semiconductor device 200 according to the first embodiment of the present invention. The areas AQ1-AQ4 of the PMOS transistors Q1-Q4 may be evenly spaced, that is, disposed at equal intervals. In FIG. 4, like reference numerals as of FIG. 3 are denoted with like reference numerals and a detailed description thereof is omitted.

In some cases, a slight amount of force may be undesirably applied to a semiconductor chip when the semiconductor chip is mounted on a package. This may cause a property of the monitor transistor (MOS transistor) to fluctuate (change), for example, the threshold of the voltage of the MOS transistor. The degree of such change is greater toward the periphery of the semiconductor chip than the center portion of the semiconductor chip. Therefore, as shown in FIGS. 3 and 4, by disposing the multiple PMOS transistors Q1-Q4 at the periphery of the area AM1 of the driver transistor M1 or within the area of the area AM1 of the driver transistor M1, the fluctuation (changes) in a property of the monitor transistor (MOS transistor) M11, which is caused when force is applied to the semiconductor chip, can be averaged (balanced). Accordingly, the property of the driver transistor M1 can be matched with the property of the monitor transistor M11.

It is to be noted that, although in FIGS. 3 and 4 describe an example in which four PMOS transistors are provided for the monitor transistor M11, PMOS transistors provided for the monitor transistor M11 are not limited to four PMOS transistors. The number may be changed by considering, for example, the size of the area AM1 at which the driver transistor M1 is formed (mounted) and/or the temperature distribution of the area AM1. It may, however, be preferable that the number of the PMOS transistors of the monitor transistor M11 be an even number for reducing the variation (fluctuation) in the property of the monitor transistor M11. Furthermore, the driver transistor M1 and the monitor transistor M11 are not limited to MOS transistors. The driver transistor M1 and the monitor transistor M11 may alternatively be bi-polar transistors or junction type FETs, for example.

Accordingly, in the semiconductor device according to the first embodiment of the present invention, the monitor transistor M11, which includes multiple PMOS transistors Q1-Q4 connected parallel to the driver transistor M1, is provided for detecting the current flowing in the driver transistor M1. By disposing the multiple PMOS transistors Q1-Q4 at the periphery of the area AM1 of the semiconductor chip 21 at which the driver transistor M1 is formed (mounted) or within the area AM1, the proportion between the current of the driver transistor M1 and the current of the monitor transistor M11 can be prevented from being affected by temperature. This allows the current of the driver transistor M1 to be detected accurately. Furthermore, the fluctuation of the transistor property, which is caused by a force created upon mounting the semiconductor chip 21 on a package, can be averaged, to thereby enable the property of the driver transistor M1 to be matched with the property of the monitor transistor M11, so that the current can be detected more accurately.

Further, the present invention is not limited to these embodiments, but variations and modifications may be made without departing from the scope of the present invention.

The present application is based on Japanese Priority Application No.2004-275293 filed on Sep. 22, 2004 with the Japanese Patent Office, the entire contents of which are hereby incorporated by reference.

1. A semiconductor device provided with a monitor transistor for detecting electric current flowing in a driver transistor mounted on a semiconductor chip, the semiconductor device comprising:
a plurality of transistors provided in the monitor transistor and connected in parallel;
wherein the plural transistors are disposed at a periphery of an area of the semiconductor chip on which the driver transistor is mounted.

2. A semiconductor device provided with a monitor transistor for detecting electric current flowing in a driver transistor mounted on a semiconductor chip, the semiconductor device comprising:
a plurality of transistors provided in the monitor transistor and connected in parallel;
wherein the plural transistors are disposed within an area of the semiconductor chip on which the driver transistor is mounted.

3. The semiconductor device as claimed in claim 1, wherein the plural transistors are disposed on the semiconductor chip at equal intervals.

4. The semiconductor device as claimed in claim 1, wherein the driver transistor and the monitor transistor are MOS transistors.

5. A voltage regulator provided with a constant voltage circuit part including a driver transistor mounted on a semiconductor chip and an output current detection circuit part including a monitor transistor for detecting electric current flowing in the driver transistor, the voltage regulator comprising:
a plurality of transistors provided in the monitor transistor and connected in parallel;
wherein the plural transistors are disposed at a periphery of an area of the semiconductor chip on which the driver transistor is mounted.

6. A voltage regulator provided with a constant voltage circuit part including a driver transistor mounted on a semiconductor chip and an output current detection circuit part including a monitor transistor for detecting electric current flowing in the driver transistor, the voltage regulator comprising:
a plurality of transistors provided in the monitor transistor and connected in parallel;
wherein the plural transistors are disposed within an area of the semiconductor chip on which the driver transistor is mounted.

7. The voltage regulator as claimed in claim 5, wherein the plural transistors are disposed on the semiconductor chip at equal intervals.

8. The voltage regulator as claimed in claim 5, wherein the output current detection circuit part is configured to change the electric current flowing in the monitor transistor into electric voltage and output the electric voltage.

9. The voltage regulator as claimed in claim 5, wherein the constant voltage circuit part further includes a reference voltage generation circuit for generating and outputting a reference voltage and an operational amplifier circuit including a differential pair for controlling the operation of the driver transistor, wherein the output current detection circuit part is configured to supply an electric current to the differential pair of the operational amplifier circuit, wherein the electric current supplied to the differential pair is proportional to the electric current flowing in the monitor transistor.

10. The voltage regulator as claimed in claim 5, wherein the driver transistor and the monitor transistor are MOS transistors.

11. The voltage regulator as claimed in claim 5, wherein the constant voltage circuit part and the output current detection circuit part are integrated on a single integrated circuit.
